(19) United States
(12) Patent Application Publication
(10) Pub. No.: US 2006/0157595 A1
(43) Pub. Date: Jul. 20, 2006

(54) Fuel injector for high fuel flow rate applications

(76) Inventors: William A. Peterson JR., Smithfield, VA (US); John F. Nally, Williamsburg, VA (US)

Correspondence Address: SIEMENS CORPORATION;INTELLECTUAL PROPERTY DEPORATION, 170 WOOD AVENUE SOUTH, ISELIN, NJ, 08830, US

(21) Appl. No.: 11/034,863

(22) Filed: Jan. 14, 2005

(51) Int. Cl. F02M 61/00

(52) U.S. Cl. 239/533.12; 239/585.1

(57) ABSTRACT

A fuel injector that provides fuel targeting and fuel spray distribution with non-angled metering orifices at higher than normal fuel flow rates is described. In a preferred embodiment, the fuel injector includes a housing, an inlet, an outlet, a seat, a metering disc, and a closure member. The seat is disposed proximate to the outlet and includes a sealing surface and a seat orifice extending through the seat from the sealing surface along the longitudinal axis to a tapered surface that extends obliquely from the seat orifice about the longitudinal axis to define a first volume. The metering disc includes a first surface disposed about the longitudinal axis and having a portion contiguous to a plane and a second surface that extends from the first surface away from the inlet and bounds a portion of the plane to define a second volume. The plurality of metering orifices is located outside a projection of the seat orifice that defines a first virtual circle on the second surface. A method of flowing fuel through the fuel injector is also described.

### BACKGROUND OF THE INVENTION

Most modern automotive fuel systems utilize fuel injectors to provide precise metering of fuel for introduction into each combustion chamber. Additionally, the fuel injector atomizes the fuel during injection, breaking the fuel into a large number of very small particles, increasing the surface area of the fuel being injected, and allowing the oxidizer, typically ambient air, to more thoroughly mix with the fuel prior to combustion. The metering and atomization of the fuel reduces combustion emissions and increases the fuel efficiency of the engine. Thus, as a general rule, the greater the precision in metering and targeting of the fuel and the greater the atomization of the fuel, the lower the emissions with greater fuel efficiency.

An electromagnetic fuel injector typically utilizes a solenoid assembly to supply an actuating force to a fuel metering assembly. Typically, the fuel metering assembly is a plunger-style needle valve which reciprocates between a closed position, where the needle is seated in a seat to prevent fuel from escaping through a metering orifice into the combustion chamber, and an open position, where the needle is lifted from the seat, allowing fuel to discharge through the metering orifice for introduction into the combustion chamber.

The fuel injector is typically mounted upstream of the intake valve in the intake manifold or proximate a cylinder head. As the intake valve opens on an intake port of the cylinder, fuel is sprayed towards the intake port. In one situation, it may be desirable to target the fuel spray at the intake valve head or stem while in another situation, it may be desirable to target the fuel spray at the intake port instead of at the intake valve. In both situations, the targeting of the fuel spray can be affected by the spray or cone pattern. Where the cone pattern has a large divergent cone shape, the fuel sprayed may impact on a surface of the intake port rather than towards its intended target. Conversely, where the cone pattern has a narrow divergence, the fuel may not atomize and may even recombine into a liquid stream. In either case, incomplete combustion may result, leading to an increase in undesirable exhaust emissions.

Complicating the requirements for targeting and spray pattern is cylinder head configuration, intake geometry and intake port specific to each engine's design. As a result, a fuel injector designed for a specified cone pattern and targeting of the fuel spray may work extremely well in one type of engine configuration but may present emissions and drivability issues upon installation in a different type of engine configuration. Additionally, as more and more vehicles are produced using various configurations of engines (for example: inline-4, inline-6, V-6, V-8, V-12, W-8 etc.,), emission standards have become stricter, leading to tighter metering, spray targeting and spray or cone pattern requirements of the fuel injector for each engine configuration.

Further complicating the issue is the problem of forced induction engines that may require higher fuel flow rates to operate. It is believed that the conventional induction engine operates at a fuel flow rate from 0.1 grams/second to 3 grams/second at various fuel pressures, typically 200-600 kiloPascals, while forced induction engines may require an elevated fuel flow rate of 6 grams/second or higher at various fuel pressures to meet the elevated air intake volume of the engine. It is believed that conventional fuel injectors have difficulty operating at these elevated fuel flow rates.

It would be beneficial to develop a fuel injector in which increased atomization and precise targeting can be changed so as to meet a particular fuel targeting and cone pattern from one type of engine configuration to another type. It would also be beneficial to develop a fuel injector in which non-angled metering orifices can be used in controlling atomization, spray targeting and spray distribution of fuel for forced induction engines.

### SUMMARY OF THE INVENTION

The present invention provides fuel targeting and fuel spray distribution with non-angled metering orifices at fuel flow rates suitable for forced induction engines or those requiring flow rates greater than normal. In a preferred embodiment, a fuel injector is provided. The fuel injector comprises a housing, an inlet, an outlet, a seat, a metering disc, and a closure member. The inlet and an outlet communicate with a flow of fuel that is regulated by the closure member disposed in at least two positions along the longitudinal axis. The seat is disposed proximate to the outlet and includes a sealing surface contiguous to a portion of the closure member in one of the two positions of the closure member and a seat orifice extending through the seat from the sealing surface along the longitudinal axis to a tapered surface that extends obliquely from the seat orifice about the longitudinal axis to define a first volume. The metering disc includes a first surface disposed about the longitudinal axis and having a portion contiguous to a plane and a second surface that extends from the first surface away from the inlet and bounds a portion of the plane to define a second volume. The metering orifices extend through the second surface to a third surface, the plurality of metering orifices being located outside a projection of the seat orifice that define a first virtual circle on the second surface.

In yet another embodiment, a method of flowing fuel through at least one metering orifice of a fuel injector is provided. The fuel injector has an inlet and an outlet and a passage extending along a longitudinal axis therethrough. The outlet has a seat with a seat orifice and a first channel surface extending obliquely to the longitudinal axis. The outlet also has a metering disc with a second channel surface confronting the first channel surface so as to provide a frustoconical flow channel and a plurality of metering orifices extending generally parallel to the longitudinal axis and located about the longitudinal axis. The method can be achieved by: passing fluid with a mass flow rate of at least 0.1 grams per second through a volume disposed between the seat orifice and the metering disc; and metering a mass flow rate of about 5 grams per second through the plurality of the metering orifices at second angle greater than the first oblique angle.

### BRIEF DESCRIPTIONS OF THE DRAWINGS

The accompanying drawings, which are incorporated herein and constitute part of this specification, illustrate an embodiment of the invention, and, together with the general description given above and the detailed description given below, serve to explain the features of the invention.

FIG. 1 illustrates a preferred embodiment of the fuel injector.

FIG. 2A illustrates a close-up perspective view of an outlet end of the fuel injector of FIG. 1.

FIG. 2B illustrates a cross-sectional view of the preferred embodiment of a seat subassembly that, in particular, shows the various relationships between various components in the subassembly.

FIG. 2C illustrates a perspective view of a metering orifice of FIG. 2A.

### DETAILED DESCRIPTION OF THE PREFERRED EMBODIMENTS

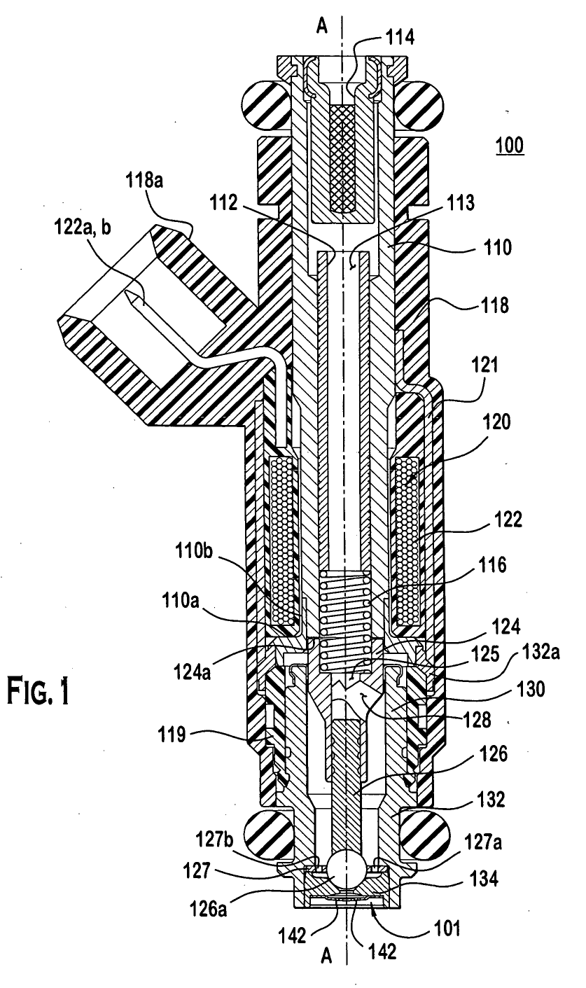

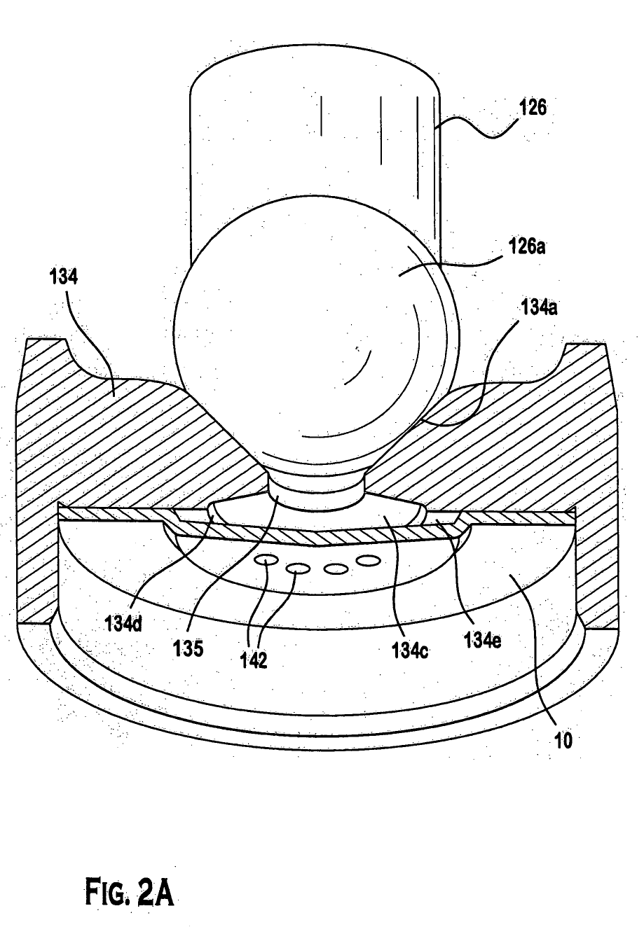

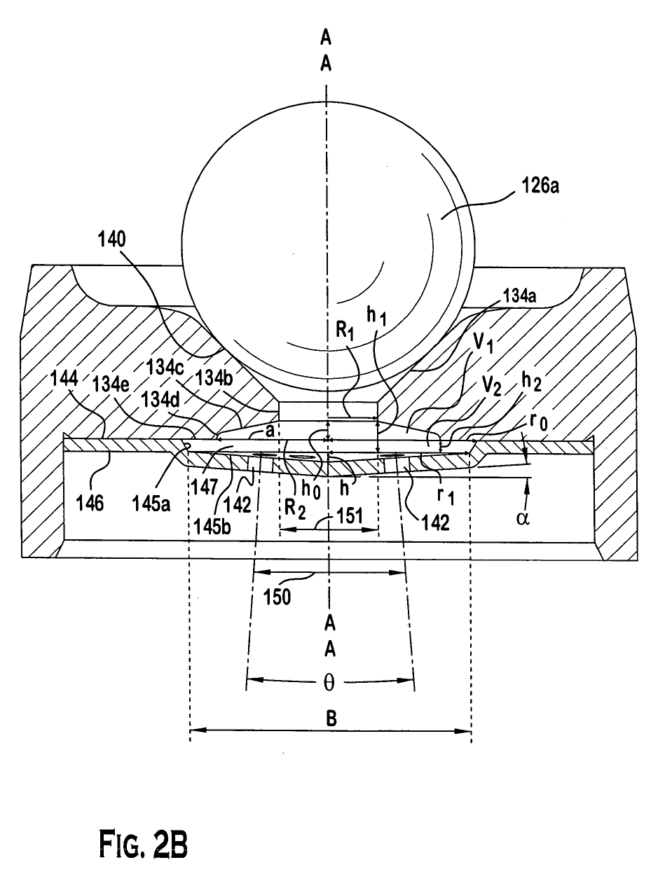

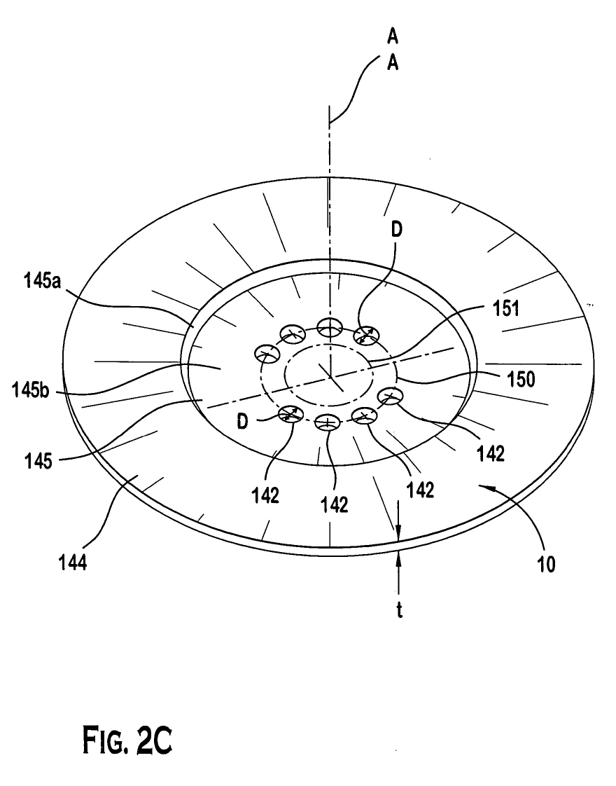

FIGS. 1, 2A, 2B, and 2C illustrate the preferred embodiments. In particular, a fuel injector 100 having a preferred embodiment of the metering disc 10 is illustrated in FIG. 1. The fuel injector 100 includes: a fuel inlet tube 110, an adjustment tube 112, a filter assembly 114, a coil assembly 120, a coil spring 116, an armature 124, a closure member 126, a non-magnetic shell 110a, a first overmold 118, a valve body 130, a valve body shell 132a, a second overmold 119, a coil assembly housing 121, a guide member 127 for the closure member 126, a seat 134, and a metering disc 10.

The guide member 127, the seat 134, and the metering disc 10 form a stack that is coupled at the outlet end of fuel injector 100 by a suitable coupling technique, such as, for example, crimping, welding, bonding or riveting. Armature 124 and the closure member 126 are joined together to form an armature/needle valve assembly. It should be noted that one skilled in the art could form the assembly from a single component. Coil assembly 120 includes a plastic bobbin on which an electromagnetic coil 122 is wound.

Respective terminations of coil 122 connect to respective terminals 122a, 122b that are shaped and, in cooperation with a surround 118a formed as an integral part of overmold 118, to form an electrical connector for connecting the fuel injector to an electronic control circuit (not shown) that operates the fuel injector.

Fuel inlet tube 110 can be ferromagnetic and includes a fuel inlet opening at the exposed upper end. Filter assembly 114 can be fitted proximate to the open upper end of adjustment tube 112 to filter any particulate material larger than a certain size from fuel entering through inlet opening before the fuel enters adjustment tube 112.

In the calibrated fuel injector, adjustment tube 112 has been positioned axially to an axial location within fuel inlet tube 110 that compresses preloaded spring 116 to a desired bias force that urges the armature/needle valve such that the rounded tip end of closure member 126 can be seated on seat 134 to close the central hole through the seat. Preferably, tubes 110 and 112 are crimped together to maintain their relative axial positioning after adjustment calibration has been performed.

After passing through adjustment tube 112, fuel enters a volume that is cooperatively defined by confronting ends of inlet tube 110 and armature 124 and that contains preloaded spring 116. Armature 124 includes a passageway 128 that communicates volume 125 with a passageway 113 in valve body 130, and guide member 127 contains fuel passage holes 127a, 127b. This allows fuel to flow from volume 125 through passageways 113, 128 to seat 134.

Non-ferromagnetic shell 110a can be telescopically fitted on and joined to the lower end of inlet tube 110, as by a hermetic laser weld. Shell 110a has a tubular neck that telescopes over a tubular neck at the lower end of fuel inlet tube 110. Shell 110a also has a shoulder that extends radially outwardly from neck. Valve body shell 132a can be ferromagnetic and can be joined in fluid-tight manner to non-ferromagnetic shell 110a, preferably also by a hermetic laser weld.

The upper end of valve body 130 fits closely inside the lower end of valve body shell 132a and these two parts are joined together in fluid-tight manner, preferably by laser welding. Armature 124 can be guided by the inside wall of valve body 130 for axial reciprocation. Further axial guidance of the armature/needle valve assembly can be provided by a central guide hole in member 127 through which closure member 126 passes.

Prior to a discussion of the description of components of a seat subassembly proximate the outlet end of the fuel injector 100, it should be noted that the preferred embodiments of a seat and metering disc of the fuel injector 100 allow for a targeting of the fuel spray pattern (i.e., fuel spray separation) to be selected without relying on angled orifices that must be form on a generally planar work piece. Moreover, the preferred embodiments allow the cone pattern (i.e., a narrow or large divergent cone spray pattern) to be selected based on the preferred spatial orientation of straight (i.e. parallel to the longitudinal axis) orifices. The variation of cone spray patterns described in U.S. patent application Ser. Nos. 10/162,759; 10/183,406; 10/183,392; 10/253,467; 10/253,499; 10/323,642; 10/753,378: 10/753,481; and 10/753,377, which applications are hereby incorporated by reference in their entireties into this application.

Referring to a close up illustration of the seat subassembly in FIG. 2A of the fuel injector 100 which has a closure member 126, seat 134, and a metering disc 10. The closure member 126 includes a spherical surface shaped member 126a disposed at one end distal to the armature. The spherical member 126a engages the seat 134 on seat surface 134a so as to form a generally line contact seal 140 between the two members as shown in FIG. 2B. The seat surface 134a tapers radially downward and inward toward the seat orifice 135 such that the surface 134a is oblique to the longitudinal axis A-A. The words “inward” and “outward” refer to directions toward and away from, respectively, the longitudinal axis A-A. The seal can be defined as a sealing circle 140 formed by contiguous engagement of the spherical member 126a with the seat surface 134a, shown in FIG. 2B. The seat 134 includes a seat orifice 135, which extends generally along the longitudinal axis A-A of the housing 20 and is formed by a generally cylindrical wall 134b. Preferably, a center 135a of the seat orifice 135 is located generally on the longitudinal axis A-A and the seat orifice 135 has a diameter of about 1.1 millimeters.

Downstream of the circular wall 134b, the seat 134 tapers along a taper portion 134c towards the metering disc 10. The taper portion 134c preferably can be linear or curvilinear with respect to the longitudinal axis A-A, such as, for example, a curvilinear taper that forms a portion of a dome-like first volume as shown in FIG. 2B. The taper portion 134c is tapered downward and outward at an angle away from the seat orifice 135 to a point radially past the metering orifices 142. At this point, the seat 134 extends along and is substantially parallel to the longitudinal axis A-A so as to preferably form a cylindrical wall surface 134d. The wall surface 134d extends downward and subsequently extends in a generally radial direction to form a bottom surface 134e, which is preferably perpendicular to the longitudinal axis A-A. The dome-like first volume is located between the seat orifice and the wall surface 134d. In a preferred embodiment, the dome-like volume may be approximated by using the formula V₁=⅙πh(3a²+hₒ²) where “a” is a radius at the base of the dome-like first volume and hₒ is the height of the dome-like first volume to the base from the seat orifice 135. Preferably, the dome-like first volume has a volume of about 1 cubic millimeter.

The interior surface 144 of the metering disc 10 proximate its outer perimeter, engages the bottom surface 134e along a generally annular contact area. The seat orifice 135 is preferably located wholly within the perimeter, i.e., a “bolt circle” 150 defined by an imaginary line connecting a center of each of the metering orifices 142, as shown in FIG. 2C. That is, a virtual extension of the surface of the seat 135 generates a virtual circle 151 preferably disposed within the bolt circle 150.

The circular metering disc 10 is located between the seat 134 and the outlet of the fuel injector. The interior surface 144 of the metering disc 10 is located about the longitudinal axis A-A and having a portion contiguous to a plane rotated around the longitudinal axis A-A. The metering disc 10 also has an inner surface 145 that extends from the interior surface 144 and encompasses an inverted dome-like second volume. A first sloped portion 145a, of the inner surface 145, slopes away from the interior surface 144 at about 60° angle with respect to a plane perpendicular to the longitudinal axis A-A for a vertical distance of about 0.05 to 0.20 millimeters. Preferably, the vertical distance is about 0.06 millimeters. A second sloped portion 145b, of the inner surface 145, slopes inward at a dimpling angle α of about 0° to 12° with respect to a plane perpendicular to the longitudinal axis A-A toward the center located at the longitudinal axis A-A, as shown in FIGS. 2B and 2C. Preferably, the dimpling angle α is about 4° to 8°.

The metering disc 10 has metering orifices 142 that extend through the inner surface 145 to an outside surface 146 proximate the outlet. Due to the dimpling angle a, the walls of the metering orifices 142 are angled at about 4 degrees with respect to the longitudinal axis A-A. One or more metering orifices may have a diameter of about 0.15 to 0.5 millimeters and be spaced from the outside diameter of other orifices by an arcuate distance of about 0.2 to about 0.9 millimeters. The outside diameter of each metering orifice may be spaced about 0.38 millimeters from the interface between the first sloped portion 145a and the second sloped portion 145b. The metering orifices 142 are located outside a projection of the seat orifice 135 or virtual circle 151. The center of each of the metering orifices 142 may be evenly disposed on both halves of the metering disc and at an angular sector along the bolt circle 150, as shown in FIG. 2C. The metering orifices 142 are oriented generally parallel to the longitudinal axis A-A and may be disposed, at a first arcuate distance relative to each other, or at different arcuate distances around the bolt circle 150, as shown in FIGS. 2B and 2C.

In the preferred embodiment, the thickness of the metering disc 10 can be from about 75 to about 200 microns and the outer diameter of the disc can be from about 5 millimeters to about 7 millimeters. Preferably, the outer diameter of the disc can be in the range from about 5.5 to 6.5 millimeters. The metering disc 10 is preferably formed of stainless steel. The metering disc 10 can be formed by stamping, deep drawing, machining, or other suitable manufacturing methods. Preferably, the metering disc 10 is formed by punching the metering orifices on a generally flat workpiece so that the metering orifices 142 are formed with its internal wall extending generally parallel to a perpendicular axis extending through the work piece. Thereafter, the work piece can be stamped into the configuration preferably described herein.

A generally annular controlled velocity channel 147 is formed between the seat orifice 135 of the seat 134 and interior face 144 of the metering disc 10, illustrated here in FIG. 2B. Specifically, the channel 147 is initially formed between the intersection of the cylindrical surface 134b and the taper portion 134c. The channel runs along the wall surface 134d and bottom surface 134e, the first sloped portion 145a, and terminates at the intersection of the second sloped portion 145b and beyond the outside perimeter of the metering orifice 142. The second volume “V₂” of the inverted dome-like portion of the metering disc 10 can be approximated by using the formula,

$${V}_{2} = \frac{1}{3} π {r}_{0}^{2} {h}_{2} [ 1 + \frac{{r}_{0}}{{r}_{1}} + {( \frac{{r}_{0}}{{r}_{1}} )}^{2} ] + \frac{1}{6} π h ( 3 {r}_{1} + {h}^{2} )$$

where
rₒ is the radius of the base of the inverted tapered cylinder;
r₁ is the radius from the longitudinal axis A-A to the junction between the tapered cylinder and the dome;
h is the distance between the bottom of the dome to the tapered cylinder; and
h₂ is the distance from the base of the dome to the base of the tapered cylinder.

Preferably, the dome-like second volume V₂ has a volume of about 1.6 cubic millimeters although other values for the volume can be utilized.

A physical representation of a particular relationship has been discovered that allows the controlled velocity channel 147 to provide a constant velocity to fluid flowing through the channel 147. In this relationship, the channel 147 changes in cross-sectional area along the longitudinal axis as the channel 147 extends outwardly from the seat orifice 135 to the plurality of metering orifices 142 such that fuel flow is imparted with a radial velocity between the seat orifice 135 and the plurality of metering orifices 142.

In this relationship, the channel 147 tapers outwardly from a larger height h₁ at the seat orifice 135 with corresponding radial distance R₁ to a smaller height h₂ with corresponding radial distance R₂ toward the metering orifices 142. Preferably, a product of the height h₁, distance R₁ and π is approximately equal to the product of the height h₂, distance R₂ and π (i.e. R₁*h₁*π=R₂*h₂*π or R₁*h₁=R₂*h₂) formed by a taper, which can be linear or curvilinear. An annular space 148, approximately cylindrical in shape with a length R₂, is formed between the preferably linear wall surface 134d and the second sloped portion 145b of the inner surface 145 of the metering disc 10. That is, as shown in FIGS. 2B, a frustum is formed by the controlled velocity channel 147 downstream of the seat orifice 135. By providing a relatively constant velocity of fuel flowing through the controlled velocity channel 147, it is believed that a sensitivity of the position of the metering orifices 142 relative to the seat orifice 135 in spray targeting and spray distribution is minimized. In other words, due to manufacturing tolerances, acceptable level concentricity of the array of metering orifices 142 relative to the seat orifice 135 may be difficult to achieve. As such, features of the preferred embodiment are believed to provide a metering disc for a fuel injector that is believed to be less sensitive to concentricity variations between the array of metering orifices 142 on the bolt circle 150 and the seat orifice 135. It is also noted that those skilled in the art will recognize that from the particular relationship, the velocity can decrease, increase or both increase/decrease at any point throughout the length of the channel 147, depending on the configuration of the channel, including varying R₁, h₁, R₂ or h₂ of the controlled velocity channel 147, such that the product of R₁ and h₁ can be less than or greater than the product of R₂ and h₂.

In another preferred embodiment, the wall surface 134c may extend directly to the first sloped portion 145a of the metering disc 10. In such preferred embodiment, the channel 147 may impart a different radial velocity to fuel flowing through the seat orifice 135. Preferably the wall surface 134c does not extend past the outer perimeter of tapered metering disc portion 145d.

It has been discovered that the spray separation angle θ of fuel spray exiting the metering orifices 142 in the preferred embodiments is generally oblique to the longitudinal axis A-A. Preferably, the spray separation angle is approximately equal to twice the dimpling angle α (or 2α) and can be changed as a generally linear function of the radial velocity, as disclosed in U.S. patent application Ser. No. 10/162,759. The radial velocity can be changed preferably by changing the configuration of the seat subassembly (including R₁, h₁, R₂ or h₂ of the controlled velocity channel 147), changing the flow rate of the fuel injector, or by a combination of both.

Furthermore, by changing the ratio of the through-length (or orifice length) “t” of each metering orifice 142 with respect to the diameter “D” of each orifice, the spray separation targeting also may be adjusted. An increase of t/D results in a decrease in the angle of the fuel flow away from the fuel injector outlet with respect to its longitudinal axis A-A. The t/D ratio variations are also disclosed in U.S. patent application Ser. No. 10/162,759.

In operation, the fuel injector 100 is initially at the non-injecting position shown in FIG. 1. In this position, a working gap exists between the annular end face 110b of fuel inlet tube 110 and the confronting annular end face 124a of armature 124. Coil housing 121 and tube 112 are in contact at 74 (not shown) and constitute a stator structure that is associated with coil assembly 120. Non-ferromagnetic shell 110a assures that when electromagnetic coil 122 is energized, the magnetic flux will follow a path that includes armature 124. Starting at the lower axial end of housing 121, where it is joined with valve body shell 132a by a hermetic laser weld, the magnetic circuit extends through valve body shell 132a, valve body 130 and eyelet to armature 124, and from armature 124 across working gap 72 (not shown) to inlet tube 110, and back to housing 121.

When electromagnetic coil 122 is energized, the spring force on armature 124 can be overcome and the armature is attracted toward inlet tube 110 reducing working gap 72. This unseats closure member 126 from seat 134 open the fuel injector so that pressurized fuel in the valve body 130 flows through the seat orifice and through orifices formed on the metering disc 10. It should be noted here that the actuator may be mounted such that a portion of the actuator can disposed in the fuel injector and a portion can be disposed outside the fuel injector. When the coil ceases to be energized, preloaded spring 116 pushes the armature/needle valve closed on seat 134.

It has been discovered that when a suitable test fluid (e.g. N-heptane or Stoddard Solvent) at the inlet of the fuel injector 100 is pressurized at about 200 to about 600 kiloPascals and at a flow rate of at least 0.1 grams per second, the fuel injector 100 of the preferred embodiments is able to flow this test fluid through the metering disc 10 at a substantially greater rate as compared to the fuel injector disclosed in U.S. Pat. No. 6,769,625 (issued 03-Aug.-2004) while permitting the fluid to be divergent at about 4° to about 11° with respect to the longitudinal axis A-A. Because N-heptane or Stoddard Solvent has similar physical properties to commercially available gasoline, it is believed that this greater flow rate of the test fluid would correspond (under actual operating conditions) to actual flow rate for fuel such as gasoline being metered into an internal combustion engine. This greater fluid flow rate, at about 5 grams per second and greater at a pressure from 200 kiloPascals to 600 kiloPascals, along with the divergent spray targeting capability of the flow channel 147, are believed to be advantageous in forced induction applications.

As described, the preferred embodiments, including the techniques of controlling spray angle targeting and distribution are not limited to the fuel injector described but can be used in conjunction with other fuel injectors such as, for example, the fuel injector sets forth in U.S. Pat. No. 5,494,225 issued on Feb. 27, 1996, or the modular fuel injectors set forth in U.S. Pat. No. 6,676,044 issued Jan. 13, 2004, and wherein both of these documents are hereby incorporated by reference in their entireties.

While the present invention has been disclosed with reference to certain embodiments, numerous modifications, alterations and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

What I claim is:

1. A fuel injector comprising:
an inlet and an outlet and a passage extending along a longitudinal axis from the inlet to the outlet, the inlet communicable with a flow of fuel;
a closure member disposed in at least two positions along the longitudinal axis in the passage;
a seat disposed in the passage proximate the outlet, the seat including a sealing surface contiguous to a portion of the closure member in one of the two position of the closure member and a seat orifice extending through the seat from the sealing surface along the longitudinal axis to a tapered surface that extends obliquely from the seat orifice about the longitudinal axis to define a first volume;
a metering disc disposed between the seat and the outlet, the metering disc including:
a first surface disposed about the longitudinal axis and having a portion contiguous to a plane;
a second surface that extends from the first surface away from the inlet and bounds a portion of the plane to define a second volume; and
a plurality of metering orifices that extends through the second surface to a third surface, the plurality of metering orifices being located outside a projection of the seat orifice that define a first virtual circle on the second surface.

2. The fuel injector of claim 1, wherein each of the plurality of metering orifices comprises a metering orifice that extends through the second and third surfaces along an axis generally parallel to the longitudinal axis so that, when the inlet of the fuel injector is provided with a pressurized fluid at about 200 to about 500 kiloPascals, the fuel injector flows the fluid through the injector at a flow rate of about 4 to about 6 grams per second.

3. The fuel injector of claim 1, wherein the plurality of metering orifices includes at least two metering orifices disposed on a second virtual circle outside the first virtual circle.

4. The fuel injector of claim 3, wherein the plurality of metering orifices includes at least two metering orifices disposed at a first arcuate distance relative to each other on the second virtual circle.

5. The fuel injector of claim 3, wherein the plurality of metering orifices includes at least three metering orifices spaced at a first arcuate distance of about 0.9 millimeters between the adjacent perimeter of the orifices and a second arcuate distance of about 0.2 millimeters between the adjacent perimeter of the orifices on the second virtual circle.

6. The fuel injector of claim 1, wherein the fluid comprises N-heptane or Stoddard Solvent.

7. The fuel injector of claim 6, wherein the second surface and the tapered surface define a flow channel formed between the seat orifice and the plurality of metering orifices, the channel extending between a first end and a second end, the first end disposed at a first radius from the longitudinal axis and spaced at a first distance from the second surface, the second end disposed at a second radius proximate the plurality of metering orifices with respect to the longitudinal axis and spaced at a second distance from the second surface such that a product of the first radius and the first distance is equal to a product of the second radius and the second distance so as to maintain a generally constant velocity flow of fuel between the seat orifice and the second surface.

8. The fuel injector of claim 6, wherein the second surface and the tapered surface define a flow channel formed between the seat orifice and the plurality of metering orifices, the channel extending between a first end and a second end, the first end disposed at a first radius from the longitudinal axis and spaced at a first distance from the second surface, the second end disposed at a second radius proximate the plurality of metering orifices with respect to the longitudinal axis and spaced at a second distance from the second surface such that a product of the first radius and the first distance is equal to a product of the second radius and the second distance so that a flow of fluid through each of the plurality of metering orifices is generally oblique to the longitudinal axis.

9. The fuel injector of claim 8, wherein the plurality of metering orifices includes at least two metering orifices, each metering orifice having a through-length and an orifice diameter and configured such that an increase in a ratio of the through-length relative to the orifice diameter results in a decrease in an angle of the fuel flow away from the fuel injector outlet with respect to the longitudinal axis.

10. The fuel injector of claim 8, wherein each of the plurality of metering orifices comprises a generally circular through-opening having a diameter of about 0.32 millimeters.

11. The fuel injector of claim 8, wherein the spacing between adjacent metering orifices is at least 0.2 millimeters and the spacing between a dimpled circle of the metering disc and an outside perimeter the metering orifice is at least 0.38 millimeters.

12. The fuel injector of claim 8, wherein the plurality of metering orifices comprises eight metering orifices symmetric about an axis extending through the longitudinal axis to provide for four metering orifices disposed on a sector of about 180 degrees about the longitudinal axis, two of the four metering orifices are disposed at about 49 degrees with respect to each other and two other metering orifices are disposed about 33 degrees with respect to each other.

13. The fuel injector of claim 8, wherein the thickness of metering disc to its overall height is greater than ⅓.

14. The fuel injector of claim 8, wherein the metering disc has a first sloped potion of about 60° with respect to a plane perpendicular to the longitudinal axis and a second sloped portion of about 4° with respect to the plane perpendicular to the longitudinal axis.

15. The fuel injector of claim 1, wherein the second volume is greater than the first volume.

16. The fuel injector of claim 14, wherein the first and second sloped portions of the metering disc define a second volume of about 1.6 cubic millimeters.

17. The fuel injector of claim 16, wherein a sum of the first and second volume comprise 2.6 cubic millimeters, and the inside diameter of the dome is no greater than the inside diameter of the second surface about the longitudinal axis.

18. A method of flowing fuel through at least one metering orifice of a fuel injector, the fuel injector having an inlet and an outlet and a passage extending along a longitudinal axis therethrough, the outlet having a seat and a metering disc, the seat having a seat orifice and a first channel surface extending obliquely to the longitudinal axis, the metering disc including a second channel surface confronting the first channel surface to define a flow channel, the metering disc having a plurality of metering orifices extending therethrough at a first oblique angle along the longitudinal axis and located about the longitudinal axis, the method comprising:
passing fluid with a mass flow rate of at least 0.1 grams per second through a chamber disposed between the seat orifice and the metering disc; and
metering a mass flow rate of about 5 grams per second through the plurality of the metering orifices at second angle greater than the first oblique angle.

19. The method of claim 18, wherein the fluid comprises a pressurized N-heptane or Stoddard Solvent at about 200-600 kiloPascals.

20. The method of claim 18, wherein the expanding comprises flowing fluid through each of the metering orifices to define a fluid spray at a second angle greater than 4 degrees with respect to the longitudinal axis.

21. The method of claim 18, wherein the spray angle comprises an angle of about 4° to 18° with respect to the longitudinal axis, and the chamber having a volume of about 2.6 cubic millimeters.
